(19) United States
(12) Patent Application Publication
(10) Pub. No.: US 2026/0018110 A1
(43) Pub. Date: Jan. 15, 2026

(54) PIXEL CIRCUIT AND DRIVING METHOD THEREFOR, AND DISPLAY PANEL

(71) Applicant: Beijing Visionox Technology Co., Ltd., Beijing (CN)

(72) Inventors: Cuili GAI, Beijing (CN); Hongrui LI, Beijing (CN); Jianjun LU, Beijing (CN); Lei MI, Beijing (CN); Enqing GUO, Beijing (CN)

(73) Assignee: Beijing Visionox Technology Co., Ltd., Beijing (CN)

(21) Appl. No.: 19/313,894

(22) Filed: Aug. 29, 2025

(30) Foreign Application Priority Data
Aug. 30, 2024 (CN) 202411216812.X

(51) Int. Cl. G09G 3/32

(52) U.S. Cl. CPC G09G 3/32; G09G 2300/0819; G09G 2300/0852; G09G 2310/08; G09G 2330/02; G09G 2340/0435

(57) ABSTRACT

Embodiments of the present application disclose a pixel circuit and a driving method therefor, and a display panel. The pixel circuit includes a driving module, a data writing module, a coupling module, and a light-emitting module. The data writing module is connected to a first terminal of the coupling module, and a second terminal of the coupling module is connected to a control terminal of the driving module. The embodiments of the present application can shorten a row time to implement display at a high refresh rate.

### CROSS-REFERENCE TO RELATED APPLICATIONS

This application claims priority to Chinese Patent Application No. 202411216812.X, titled “PIXEL CIRCUIT AND DRIVING METHOD THEREFOR, AND DISPLAY PANEL” and filed on Aug. 30, 2024, which is hereby incorporated by reference in its entirety.

### FIELD

Embodiments of the present application relate to the field of display technologies, and in particular, to a pixel circuit and a driving method therefor, and a display panel.

### BACKGROUND

With rapid development of display technologies, there are increasingly high requirements for display of display panels, and the display panels are developing in the direction of a high resolution and a high refresh rate.

Currently, display panels in the related art have relatively low refresh rates, which cannot meet user demands.

### SUMMARY

Embodiments of the present application provide a pixel circuit and a driving method therefor, and a display panel, to implement display at a high refresh rate.

According to embodiments of the present application, a pixel circuit is provided. The pixel circuit includes:
a driving module configured to drive, in a light emission phase, a light-emitting module to emit light;
a coupling module, where a second terminal of the coupling module is connected to a control terminal of the driving module; and
a data writing module connected to a first terminal of the coupling module and configured to transmit a data voltage to the first terminal of the coupling module in different phases, and write voltage information associated with the data voltage into a control terminal of the driving module through the coupling module.

According to another embodiment of the present application, a driving method for a pixel circuit is provided, where the pixel circuit includes a driving module, a data writing module, a coupling module, and a light-emitting module, the data writing module being connected to a first terminal of the coupling module, and a second terminal of the coupling module being connected to a control terminal of the driving module.

The driving method for a pixel circuit includes:
in a first writing phase, controlling the data writing module to transmit a data voltage of a current frame to an internal node of the data writing module;
in a second writing phase, controlling the data writing module to transmit the data voltage of the current frame on the internal node of the data writing module to the first terminal of the coupling module, and controlling the coupling module to write voltage information associated with the data voltage of the current frame into the control terminal of the driving module; and
in a light emission phase, controlling the driving module to drive the light-emitting module to emit light.

According to another embodiment of the present application, a display panel is provided. The display panel includes the pixel circuit provided in any one of the embodiments of the present application.

The embodiments of the present application facilitate reducing a data writing time in a frame, and can thus shorten a row time to implement display at a high refresh rate.

### BRIEF DESCRIPTION OF THE DRAWINGS

FIG. 1 is a schematic diagram of a structure of a pixel circuit according to an embodiment of the present application;

FIG. 2 is a schematic diagram of a structure of another pixel circuit according to an embodiment of the present application;

FIG. 3 is a schematic diagram of a structure of another pixel circuit according to an embodiment of the present application;

FIG. 4 is a schematic diagram of a structure of another pixel circuit according to an embodiment of the present application;

FIG. 5 is a schematic diagram of driving timing of a pixel circuit according to an embodiment of the present application;

FIG. 6 is a schematic diagram of a structure of another pixel circuit according to an embodiment of the present application;

FIG. 7 is a schematic diagram of a structure of another pixel circuit according to an embodiment of the present application;

FIG. 8 is a schematic diagram of driving timing of another pixel circuit according to an embodiment of the present application;

FIG. 9 is a schematic diagram of a structure of another pixel circuit according to an embodiment of the present application;

FIG. 10 is a schematic diagram of a structure of another pixel circuit according to an embodiment of the present application;

FIG. 11 is a schematic diagram of driving timing of another pixel circuit according to an embodiment of the present application;

FIG. 12 is a schematic diagram of a structure of another pixel circuit according to an embodiment of the present application;

FIG. 13 is a flowchart of a driving method for a pixel circuit according to an embodiment of the present application;

FIG. 14 is a flowchart of a driving method for another pixel circuit according to an embodiment of the present application;

FIG. 15 is a flowchart of a driving method for another pixel circuit according to an embodiment of the present application;

FIG. 16 is a flowchart of a driving method for another pixel circuit according to an embodiment of the present application; and

FIG. 17 is a schematic diagram of a structure of a display panel according to an embodiment of the present application.

### DETAILED DESCRIPTION OF THE EMBODIMENTS

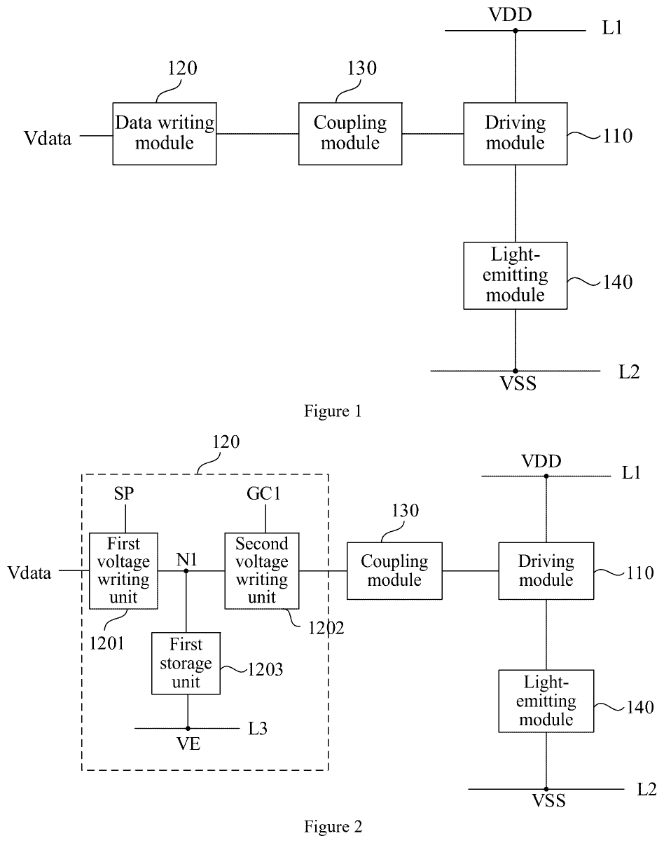

FIG. 1 is a schematic diagram of a structure of a pixel circuit according to an embodiment of the present application. Referring to FIG. 1, the pixel circuit provided in this embodiment of the present application includes a driving module 110, a data writing module 120, a coupling module 130, and a light-emitting module 140.

The data writing module 120 is connected to a first terminal of the coupling module 130, and a second terminal of the coupling module 130 is connected to a control terminal of the driving module 110. The data writing module 120 is configured to transmit a data voltage Vdata to the first terminal of the coupling module 130 in different phases, and write voltage information associated with the data voltage Vdata into the control terminal of the driving module 110 through the coupling module 130. The driving module 110 is configured to drive, in a light emission phase, the light-emitting module 140 to emit light.

Specifically, the data writing module 120 transmitting the data voltage Vdata to the first terminal of the coupling module 130 in different phases means that the data writing process is performed in different phases. In different phases, the data voltage Vdata is written into different locations, and is finally transmitted to the first terminal of the coupling module 130. For example, the data writing process includes a first writing phase and a second writing phase. In the first writing phase, the data writing module 120 is configured to transmit data voltage Vdata of a next frame to an internal node of the data writing module. In the second writing phase, the data writing module 120 is configured to transmit data voltage Vdata of the current frame to the first terminal of the coupling module 130. The first writing phase may be in a previous frame, and the second writing phase may be in the current frame. That is, the data writing module 120 is configured to write the data voltage Vdata of the current frame to the internal node of the data writing module during the previous frame, and transmit the data voltage Vdata of the current frame on the internal node to the first terminal of the coupling module 130 during the next frame. The coupling module 130 is configured to couple a voltage variation at the first terminal of the coupling module to the second terminal, that is, to a first terminal of the driving module 110. A voltage at the first terminal of the driving module 110 is associated with the data voltage Vdata of the current frame.

In the light emission phase, the driving module 110 generates a driving current based on a voltage at the control terminal of the driving module, to drive the light-emitting module 140 to emit light.

In the embodiments of the present application, the coupling module 130 is provided between a second terminal of the data writing module 120 and the control terminal of the driving module 110, and the data writing module 120 can transmit the data voltage Vdata to the first terminal of the coupling module 130 in different phases, to write the data voltage Vdata corresponding to the current frame into the internal node during the previous frame, and transmit the data voltage on the internal node to the first terminal of the coupling module 130 during the current frame, which can implement writing of the data voltage of the current frame in a phase in the previous frame, enable data writing with full utilization of a time of a light emission period, and reduce a data writing time within a frame, thereby shortening a row time to implement display at a high refresh rate.

In one embodiment, the row time is related to a resolution and a refresh rate of a display panel, and the row time is calculated based on at least the resolution and refresh rate of the display panel. For example, the row time is equal to 1/refresh rate/number of pixel rows. The number of pixel rows is associated with the resolution.

In this embodiment, the data writing module 120 is configured to transmit the data voltage Vdata of the current frame to the internal node of the data writing module 120 in the light emission phase (a first writing phase) of the previous frame, and transmit the data voltage Vdata of the current frame on the internal node of the data writing module 120 to the first terminal of the coupling module 130 in the data writing phase (a second writing phase).

Specifically, within a frame (a display period), the operating process of the pixel circuit includes at least the data writing phase and the light emission phase. In the light emission phase of the previous frame, the driving module 110 drives the light-emitting module 140 to emit light, while the data writing module 120 transmits the data voltage Vdata of the next frame to the internal node of the data writing module and stores the data voltage on the internal node.

At the time of arrival of the next frame (i.e., the current frame), in the data writing phase, the data writing module 120 is controlled to transmit the data voltage Vdata of the current frame stored on the internal node to the first terminal of the coupling module 130, and the coupling module 130 is controlled to couple the voltage variation at the first terminal of the coupling module to the second terminal (i.e., the control terminal of the driving module 110), thereby writing information including the data voltage Vdata of the current frame into the control terminal of the driving module 110.

In the light emission phase, the driving module 110 is controlled to drive the light-emitting module 140 to emit light based on voltage information including the data voltage Vdata of the current frame at the control terminal of the driving module. Meanwhile, the data writing module 120 is controlled to write the data voltage Vdata of the next frame.

FIG. 2 is a schematic diagram of a structure of another pixel circuit according to an embodiment of the present application. Referring to FIG. 2, on the basis of the above embodiment, the data writing module 120 includes a first voltage writing unit 1201, a second voltage writing unit 1202, and a first storage unit 1203. A first terminal of the first voltage writing unit 1201 is connected to a data line, a second terminal of the first voltage writing unit 1201 and a first terminal of the second voltage writing unit 1202 are connected to a first node N1, a second terminal of the second voltage writing unit 1202 is connected to the first terminal of the coupling module 130, a control terminal of the first voltage writing unit 1201 is connected to a scan signal line, a control terminal of the second voltage writing unit 1202 is connected to a first control signal line, and the first storage unit 1203 is connected between a fixed signal line L3 and the first node N1. The internal node of the data writing module 120 includes the first node N1.

The first voltage writing unit 1201 is configured to write the data voltage Vdata of the current frame into the first node N1 in the light emission phase of the previous frame, and the second voltage writing unit 1202 is configured to transmit the data voltage Vdata of the current frame on the first node N1 to the first terminal of the coupling module 130 in the data writing phase of the current frame.

Specifically, the scan signal line is configured to transmit a scan signal SP, and the first control signal line is configured to transmit a first control signal GC1. In the light emission phase of the previous frame, for example, a light emission phase of an (n−1)^{th} frame, the first voltage writing unit 1201 is controlled to be turned on in response to the scan signal SP, the second voltage writing unit 1202 is controlled to be turned off in response to the first control signal GC1, and a data voltage Vdata of an nth frame transmitted on the data line is written into the first node N1 and stored on the first storage unit 1203. At the time of arrival of the current frame (i.e., the nth frame), in the data writing phase, the first voltage writing unit 1201 is controlled to be turned off in response to the scan signal SP, the second voltage writing unit 1202 is controlled to be turned on in response to the first control signal GC1, the data voltage Vdata of the current frame stored on the first storage unit 1203 is transmitted to the first terminal of the coupling module 130 through the second voltage writing unit 1202, and the coupling module 130 couples the voltage variation at the first terminal of the coupling module to the control terminal of the driving module 110, thereby implementing data writing. In the light emission phase (the light emission phase of the nth frame), the driving module 110 is controlled to drive the light-emitting module 140 to emit light, and meanwhile a data voltage Vdata of an (n+1)^{th} frame is written into the first node N1. n is an integer greater than 1.

In this embodiment, the data voltage Vdata is written in two sessions. In the first session, the data voltage Vdata of the next frame is written into the first node N1 through the first voltage writing unit 1201 in the light emission phase of the previous frame. In the second session, the data voltage Vdata of the current frame stored on the first node N1 in the previous frame is written into the first terminal of the coupling module 130 in the data writing phase of the current frame. In other words, the data voltage Vdata corresponding to the current frame is provided by the first storage unit 1203, and during display of the current frame, the data voltage Vdata corresponding to the next frame is transmitted on the data line, and the data voltage Vdata is stored on the first storage unit 1203 for use in the next frame. Since the light emission process of the light-emitting module 140 does not affect the writing process of the data voltage Vdata, the data voltage Vdata of the next frame may be written in the light emission phase, and the data voltage Vdata is directly written by the coupling module 130 into the control terminal of the driving module 110 in the next frame, which can reduce a data writing time and thereby increase a refresh rate compared with a conventional way of writing a data voltage by a compensation module.

In this embodiment, the scan signal SP is a row-by-row signal, and the first control signal GC1 is a global signal. That is, in the (n−1)^{th} frame, the first voltage writing units 1201 in all rows of pixel circuits are turned on row by row in response to the scan signal SP, and the data voltage Vdata corresponding to the nth frame is written row by row. In the nth frame, all rows of pixel circuits are simultaneously turned on in response to the first control signal GC1, and the second voltage writing unit 1202 transmits the data voltage Vdata of the nth frame stored on the first node N1 to the first terminal of the coupling module 130, thereby enabling full-screen light emission in the light emission phase. Compared with the solution of row-by-row light emission, full-screen light emission reduces the occurrence of a flicker problem caused by dragging a brightness bar.

In this embodiment, row-by-row writing of the data voltage Vdata of the current frame into the internal node of the data writing module 120 in the light emission phase of the previous frame and full-screen writing of the data voltage Vdata of the current frame stored on the internal nodes of the data writing modules 120 during the current frame can significantly shorten a row time, thereby implementing display at a high refresh rate.

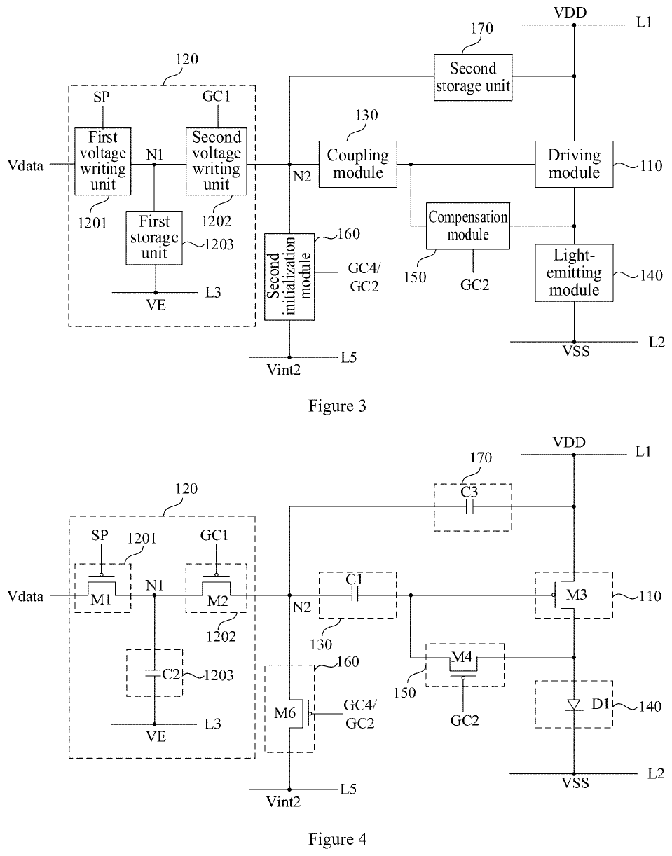

FIG. 3 is a schematic diagram of a structure of another pixel circuit according to an embodiment of the present application. Referring to FIG. 3, on the basis of the above embodiments, the pixel circuit further includes a compensation module 150. The compensation module 150 is connected to the driving module 110, a control terminal of the compensation module 150 is connected to a second control signal line configured to transmit a second control signal GC2, and the compensation module 150 is configured to initialize the control terminal of the driving module 110 in an initialization phase and compensate for a threshold voltage of the driving module 110 in a compensation phase.

An initialization phase of the current frame is before a compensation phase of the current frame and after a light emission phase of the previous frame. That is, the initialization phase and the compensation phase are between the first writing phase and the second writing phase, and the initialization phase is before the compensation phase. The first writing phase may be the light emission phase of the previous frame, and the second writing phase may be the data writing phase of the current frame. The data writing phase of the current frame is after the compensation phase of the frame and before a light emission phase of the current frame.

Specifically, the driving module 110 and the light-emitting module 140 are connected in series between a first power supply line L1 and a second power supply line L2, the first terminal of the driving module 110 is connected to the first power supply line L1, a second terminal of the driving module 110 is connected to a first terminal of the light-emitting module 140, and a second terminal of the light-emitting module 140 is connected to the second power supply line L2. The first power supply line L1 may be configured to transmit a first power supply voltage VDD, and the second power supply line L2 may be configured to transmit a second power supply voltage VSS.

In this embodiment, the first power supply voltage VDD transmitted on the first power supply line L1 is a variable signal, and the second power supply voltage VSS transmitted on the second power supply line L2 is a variable signal. For example, the first power supply voltage VDD includes a first potential and a second potential, and the second power supply voltage VSS includes a third potential and a fourth potential. In the initialization phase, the first power supply voltage VDD is configured to be switched from the second potential to the first potential, the second power supply voltage VSS is configured to be switched from the third potential to the fourth potential, and the compensation module 150 is configured to pull a potential at the control terminal of the driving module 110 in the initialization phase based on the first power supply voltage VDD having the first potential and the second power supply voltage VSS having the fourth potential, to initialize the control terminal of the driving module 110.

The first potential is less than the second potential, the third potential is less than the fourth potential, and a voltage difference between the first potential and the fourth potential is less than a turn-on voltage of the light-emitting module 140, to ensure that the light-emitting module 140 does not emit light in the initialization phase. In one embodiment, the first potential and the third potential may be negative values, and the second potential and the fourth potential may be positive values.

Specifically, in the initialization phase, the first power supply voltage VDD is switched from the second potential at a high level to the first potential at a low level, and the second power supply voltage VSS is switched from the third potential at a low level to the fourth potential at a high level. The light-emitting module 140 includes a light-emitting diode, which may be equivalent to a capacitor. Therefore, when the second power supply voltage VSS is switched from the low level to the high level, a voltage at the second terminal of the driving module 110 increases synchronously. The second terminal of the driving module 110 leaks current to the first power supply line L1, and the voltage at the second terminal of the driving module 110 decreases. Since the compensation module 150 is turned on, the control terminal and the second terminal of the driving module 110 are at the same potential, and the potential at the control terminal of the driving module 110 decreases. Moreover, since the first power supply voltage VDD is switched from the high level to the low level, the potential at the control terminal of the driving module 110 synchronously decreases under the effect of coupling of a parasitic capacitance in the driving module 110, thereby implementing initialization of the potential at the control terminal of the driving module 110.

In addition, in the initialization phase, since the second control signal GC2 connected to the control terminal of the compensation module 150 is switched from a turn-off level to a turn-on level, such as from a high level to a low level, the potential at the control terminal of the driving module 110 is pulled down under the effect of coupling of the parasitic capacitance in the compensation module 150, to enable further initialization of the potential at the control terminal of the driving module 110, thereby ensuring an initialization effect.

In the compensation phase, the first power supply voltage VDD is configured to be switched from the first potential to the second potential, the second power supply voltage VSS is configured to remain at the fourth potential, and the compensation module 150 is configured to compensate for the threshold voltage of the driving module 110 in the compensation phase based on the first power supply voltage VDD having the second potential. In this embodiment, the initialized potential at the control terminal of the driving module 110 is less than the second potential at the first power supply voltage VDD, to ensure smooth operation of the compensation phase.

Specifically, in the compensation phase, the first power supply voltage VDD is switched to the high level, the second power supply voltage VSS remains at the high level in the initialization phase, and the first power supply voltage VDD charges the control terminal of the driving module 110 through the compensation module 150. When a potential difference between the control terminal and the first terminal of the driving module 150 is equal to the threshold voltage of the driving module 110, the driving module 110 is turned off, and the compensation phase ends.

In this embodiment of the present application, the first power supply voltage VDD and the second power supply voltage VSS are set as variable signals, and the first supply switching voltage VDD and the second power supply voltage VSS are switched to implement initialization of the driving module 110 and compensation for the threshold voltage of the driving module, which eliminates the need to provide a light emission control module, thereby simplifying the circuit structure. In addition, since the compensation phase is separate from the data writing phase (the second writing phase) in terms of time, the time for the threshold voltage compensation is not limited by a row time, and full compensation for the threshold voltage of the driving module 110 can be implemented even at a high refresh rate. Therefore, a difference between characteristics of the driving module 110 at different pixels and different gray scales can be reduced, thereby facilitating mitigation of variations in display brightness and an improvement in the uniformity of display quality.

Still referring to FIG. 3, in one embodiment, the pixel circuit further includes a second initialization module 160. The second initialization module 160 is connected between a second initialization signal line L5 and the first terminal of the coupling module 130, where a control terminal of the second initialization module 160 is connected to a fourth control signal line configured to transmit a fourth control signal GC4, and the second initialization module 160 is configured to transmit a second initialization voltage Vint2 on the second initialization signal line L5 to the first terminal of the coupling module 130 in the initialization phase and the compensation phase, to stabilize the potential at the first terminal of the coupling module 130.

In one embodiment, a fixed voltage VE transmitted on the fixed signal line L3 may be the second initialization voltage Vint2, or may be the first power supply voltage VDD. When the fixed voltage VE is the first power supply voltage VDD, since the first power supply voltage VDD is a variable signal, when the first power supply voltage VDD jumps to a low level in the initialization phase, a voltage on the first node N1 decreases under the effect of coupling of the first storage unit 1203; and when the first power supply voltage VDD returns to a high level in the compensation phase, the voltage on the first node N1 returns to a corresponding data voltage Vdata. Therefore, the jump of the first power supply voltage VDD does not affect the final voltage on the first node N1 and a result of writing the data voltage Vdata.

In one embodiment, the first power supply line L1 may be reused as the fixed signal line L3.

In this embodiment, the second initialization voltage Vint2 may be a positive voltage or a negative voltage, which may be specifically set according to actual circuit demands.

In one embodiment, still referring to FIG. 3, the pixel circuit further includes a second storage unit 170. A first terminal of the second storage unit 170 is connected to the first terminal of the driving module 110, a second terminal of the second storage unit 170 is connected to the first terminal of the coupling module, and the second storage unit 170 is configured to store the voltage at a second node N2 (i.e., the first terminal of the coupling module 130).

FIG. 4 is a schematic diagram of a structure of another pixel circuit according to an embodiment of the present application, which is specifically a schematic diagram of the pixel circuit shown in FIG. 3 that is refined into a device. Referring to FIG. 4, the first voltage writing unit 1201 includes a first transistor M1, the second voltage writing unit 1202 includes a second transistor M2, the coupling module 130 includes a first capacitor C1, the first storage unit 1203 includes a second capacitor C2, the driving module 110 includes a third transistor M3, the compensation module 150 includes a fourth transistor M4, and the light-emitting module 140 includes a light-emitting diode D1. A first electrode of the first transistor M1 is connected to the data line, a second electrode of the first transistor M1 is connected to the first node N1, a gate of the first transistor M1 is connected to the scan signal line, a first electrode of the second transistor M2 is connected to the first node N1, a second electrode of the second transistor M2 is connected to a first electrode of the first capacitor C1, a second electrode of the first capacitor C1 is connected to the control terminal of the driving module 110 (i.e., a gate of the third transistor M3), a gate of the second transistor M2 is connected to the first control signal line, a first electrode of the second capacitor C2 is connected to the fixed signal line L3, and a second electrode of the second capacitor C2 is connected to the first node N1. A first electrode of the third transistor M3 is connected as the first terminal of the driving module 110 to the first power supply line L1, a second electrode of the third transistor M3 is connected as the second terminal of the driving module 110 to a first electrode of the light-emitting diode D1, a second electrode of the light-emitting diode D1 is connected to the second power supply line L2, a first electrode of the fourth transistor M4 is connected to the second electrode of the third transistor M3, a second electrode of the fourth transistor M4 is connected to the gate of the third transistor M3, and a gate of the fourth transistor M4 is connected to the second control signal line.

The second initialization module 160 includes a sixth transistor M6, where a gate of the sixth transistor M6 is connected to a fourth control signal line, a first electrode of the sixth transistor M6 is connected to the second initialization signal line L5, and a second electrode of the sixth transistor M6 is connected to the first terminal of the coupling module 130 (i.e., the second node N2). The second storage unit 170 includes a third capacitor C3, where a first electrode of the third capacitor C3 is connected to the first terminal of the driving module 110, and a second electrode of the third capacitor C3 is connected to the first terminal of the coupling module 130.

The third transistor M3 is a P-type transistor, and the other transistors may be P-type or N-type transistors. In one embodiment, the second control signal line may be reused as the fourth control signal line.

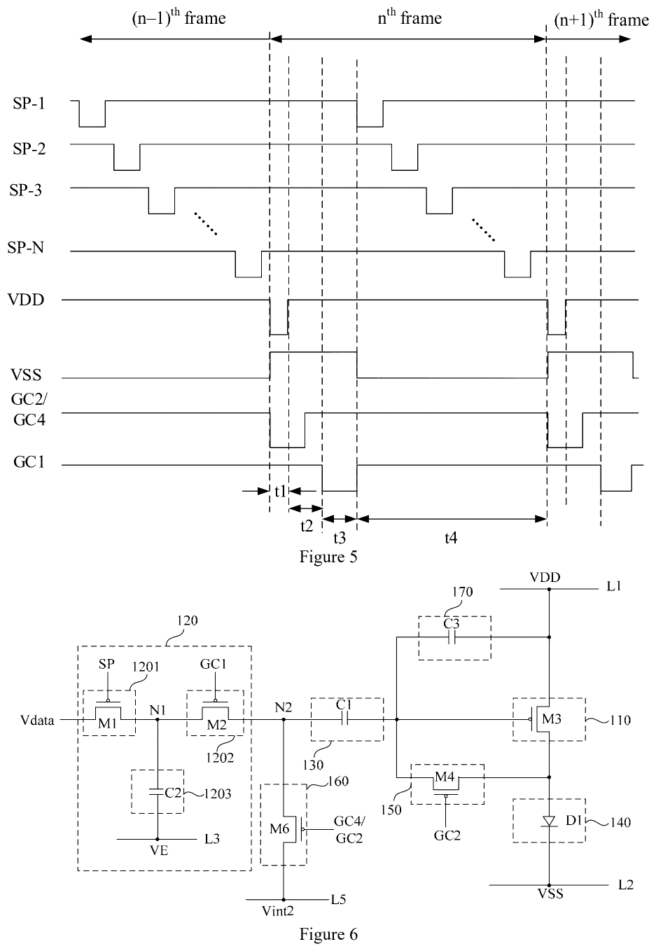

FIG. 5 is a schematic diagram of driving timing of a pixel circuit according to an embodiment of the present application. The driving timing is applicable to the pixel circuit shown in FIG. 4. With reference to FIG. 4 and FIG. 5, the operating process of the pixel circuit provided in this embodiment within a frame includes an initialization phase t1, a compensation phase t2, a data writing phase t3, and a light emission phase t4 in sequence.

In a light emission phase of the (n−1)^{th} frame (i.e., the first writing phase), the third transistor M3 drives the light-emitting diode 1 to emit light. Meanwhile, the first transistor M1 is turned on in response to the scan signal SP (SP1 corresponds to first transistors M1 of a first row of pixel circuits, SP2 corresponds to first transistors M1 of a second row of pixel circuits, SP3 corresponds to first transistors M1 of a third row of pixel circuits, and SPN corresponds to first transistors M1 of an N^{th} row of pixel circuits, N being an integer greater than or equal to 1), and the data voltage Vdata of the (n−1)^{th} frame is written into the first nodes N1 row by row and stored on the second capacitors C2.

In the n^{th} frame:
in the initialization phase t1, the first power supply voltage VDD is at a low level, the second power supply voltage VSS is at a high level, the scan signal SP is at a high level, the first control signal GC1 is at a high level, and the second control signal GC2 and the fourth control signal GC4 are both at a low level. Therefore, the fourth transistor M4 and the sixth transistor M6 are turned on. The second initialization voltage Vint2 on the second initialization signal line L5 is transmitted to the second node N2 through the sixth transistor M6. Meanwhile, when the first power supply voltage VDD jumps to a low level and the second power supply voltage VSS jumps to a high level, a voltage at the first electrode of the third transistor M3 decreases, and a voltage at the second electrode of the third transistor increases. The second electrode of the third transistor M3 leaks current to the first electrode, and the voltage at the second electrode of the third transistor M3 decreases. Since the fourth transistor M4 is turned on, a voltage at the gate of the third transistor M3 decreases.

In addition, when the first power supply voltage VDD jumps from the high level to the low level, a voltage at the gate of the third transistor M3 is pulled down under the effect of a parasitic capacitance in the third transistor M3. When the second control signal GC2 jumps from the high level to the low level, the voltage at the gate of the third transistor M3 is further pulled down under the effect of a parasitic capacitance in the fourth transistor M4. That is, in the initialization phase t1, an initialization process of the gate of the third transistor M3 includes three parts. In the first part, the second electrode of the third transistor M3 leaks current, pulling down the voltage at the gate of the third transistor M3. In the second part, the first power supply voltage VDD jumps, pulling down the voltage at the gate of the third transistor M3. In the third part, the second control signal GC2 jumps, pulling down the voltage at the gate of the third transistor M3. By pulling down the voltage at the gate of the third transistor M3 in the three parts, the gate of the third transistor M3 can be fully initialized. The first electrode of the light-emitting diode D1 is also initialized.

In the compensation phase t2, the first power supply voltage VDD is at a high level, the second power supply voltage VSS is at a high level, the scan signal SP is at a high level, the first control signal GC1 is at a high level, and the second control signal GC2 and the fourth control signal GC4 are both at a low level. Therefore, the fourth transistor M4 and the sixth transistor M6 remains turned on. The second initialization voltage Vint2 on the second initialization signal line L5 is transmitted to the second node N2 through the sixth transistor M6, to maintain a stable voltage on the second node N2. The first power supply voltage VDD charges the gate of the third transistor M3 through the third transistor M3 and the fourth transistor M4. When the voltage at the gate of the third transistor M3 reaches VDD+Vth3, the third transistor M3 is turned off, thereby implementing compensation for a threshold voltage of the third transistor M3. Vth3 is the threshold voltage of the third transistor M3.

In the data writing phase t3 (the second writing phase), the first power supply voltage VDD is at a high level, the second power supply voltage VSS is at a high level, the scan signal SP is at a high level, the first control signal GC1 is at a low level, and the second control signal GC2 and the fourth control signal GC4 are both at a high level. Therefore, the second transistor M2 is turned on, and the other transistors are all turned off. The data voltage Vdata at the first node N1 is transmitted to the second node N2 through the second transistor M2. According to the principle of capacitive coupling and constant total charge, the voltage at the second node N2 is changed to (c3*Vint2+c2*Vdata)/(c3+c2), where c3 is a capacitance value of the third capacitor C3, and c2 is a capacitance value of the second capacitor C2. Under the effect of coupling of the first capacitor C1, the voltage at the gate of the third transistor M3 is changed to VDD+Vth3+(Vdata−Vint2)*c2/(c3+c2), thereby implementing writing of the data voltage Vdata into the gate of the third transistor M3. Here, the data voltage Vdata is the data voltage Vdata written into the first node N1 in the light emission phase of the (n−1)^{th} frame.

In the light emission phase t4, the first power supply voltage VDD is at a high level, the second power supply voltage VSS is at a low level, the first control signal GC1 is at a high level, and the second control signal GC2 and the fourth control signal GC4 are both at a high level. The third transistor M3 generates a driving current I based on the voltages at the gate and the first electrode, to drive the light-emitting diode D1 to emit light.

The driving current I may be expressed as:

Id=½ μC_{OX}W/L[VDD+Vth3+(Vdata−Vint2)*c2/(c3+c2)−VDD−Vth3]²=½ μC_{OX}W/L[(Vdata−Vint2)*c2/(c3+c2)]².

μ is an electron mobility of the third transistor M3, Cox is a channel capacitance per unit area of the third transistor M3, W/L is a width-to-length ratio of the third transistor M3, and Vth3 is the threshold voltage of the third transistor M3.

It can be learned from the above formula that the driving current I is correlated to the data voltage Vdata and the second initialization voltage Vint2, and is independent of the threshold voltage Vth3 of the third transistor M3. Therefore, the threshold voltage Vth3 of the third transistor M3 does not affect the magnitude of the driving current I. In addition, since the driving current I is not affected by the second power supply voltage VSS, compensation for an IR drop of the second power supply voltage VSS can be implemented.

Meanwhile, in the light emission phase t4, the scan signal SP is at a low level, the first transistor M1 is turned on, and the data voltage Vdata of the (n+1)^{th} frame is written into the first node N1 row by row.

In this embodiment, the first control signal GC1, the second control signal GC2, and the fourth control signal GC4 are all global signals, and the initialization phase t1, the compensation phase t2, and the data writing phase t3 are simultaneously performed in all rows of pixel circuits.

In this embodiment, row-by-row writing of the data voltage Vdata of the nth frame into the first node N1 inside the data writing module 120 in the light emission phase of the (n−1)^{th} frame, and full-screen initialization, threshold voltage compensation, and transmission of the data voltage Vdata of the nth frame stored on the first node N1 to the second node N2 during the nth frame can significantly shorten a row time, thereby implementing display at a high refresh rate. In addition, since the initialization process is separate from the threshold voltage compensation process, the time for the threshold voltage compensation is not limited by the row time, thereby facilitating an improvement in the uniformity of screen display.

FIG. 6 is a schematic diagram of a structure of another pixel circuit according to an embodiment of the present application. Referring to FIG. 6, a difference between the pixel circuit in this figure and the pixel circuit shown in FIG. 4 lies in a connection relationship of the second storage unit 170 (i.e., the third capacitor C3). Here, the first terminal of the second storage unit 170 is connected to the first terminal of the driving module 110, the second terminal of the second storage unit 170 is connected to the control terminal of the driving module 110, and the second storage unit 170 is configured to store a voltage at the control terminal of the driving module 110.

The operating process of the pixel circuit shown in FIG. 6 is similar to the operating process of the pixel circuit shown in FIG. 4, only except for a change in a voltage at part of the nodes. The driving timing shown in FIG. 5 is applicable to both the operating processes. Details are not described herein.

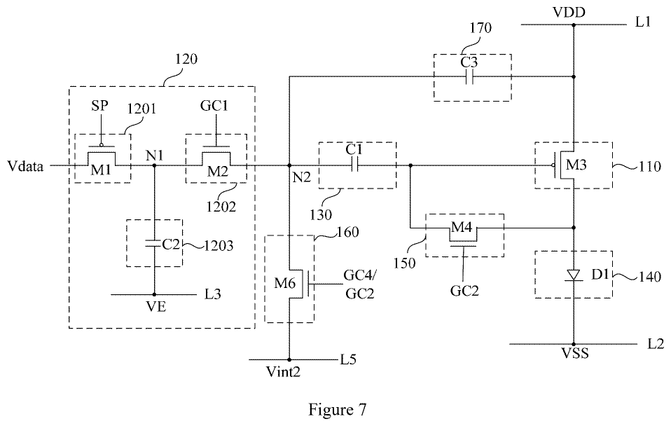

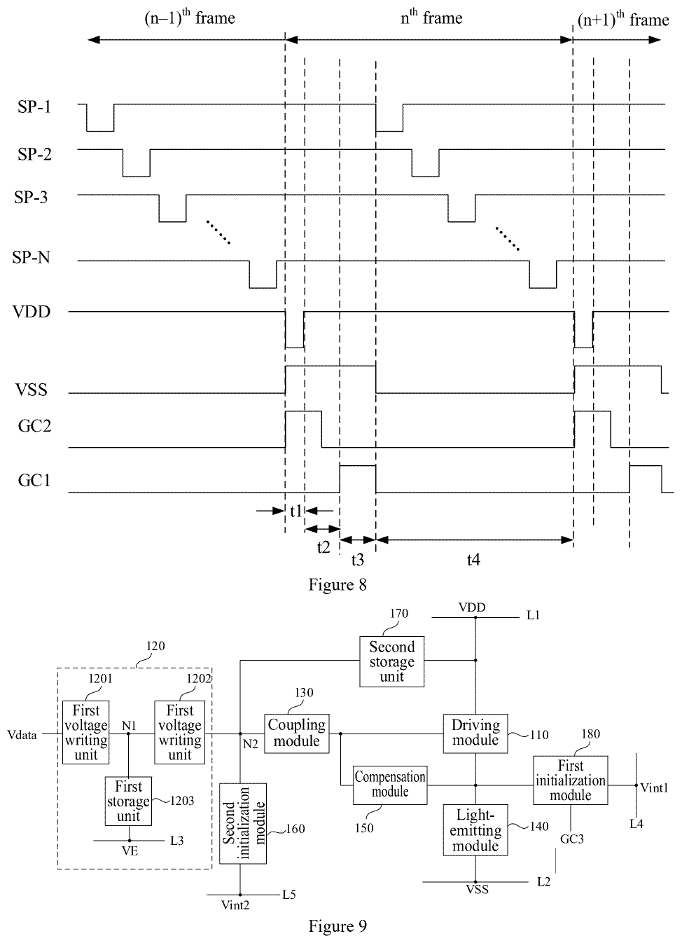

FIG. 7 is a schematic diagram of a structure of another pixel circuit according to an embodiment of the present application. Referring to FIG. 7, a difference between the pixel circuit in this figure and the pixel circuit shown in FIG. 4 lies in that part of the transistors are replaced with N-type transistors. For example, the second transistor M2, the fourth transistor M4, and the sixth transistor M6 are replaced with N-type transistors, and the first transistor M1 and the third transistor M3 remain P-type transistors. FIG. 8 is a schematic diagram of driving timing of another pixel circuit according to an embodiment of the present application. The driving timing is applicable to the pixel circuit shown in FIG. 7. In this figure, a turn-on level of an N-type transistor changes to a high level, and a turn-off level thereof changes to a low level. The operating process of the pixel circuit shown in FIG. 7 is the same as the operating process of the pixel circuit shown in FIG. 4, which will not be repeated.

In another optional implementation provided for this embodiment, the first power supply voltage VDD transmitted on the first power supply line L1 and the second power supply voltage VSS transmitted on the second power supply line L2 are both fixed signals, that is, the first power supply voltage VDD and the second power supply voltage VSS both remain unchanged, and the first power supply voltage VDD is greater than the second power supply voltage VSS. For example, the first power supply voltage VDD is a positive voltage, and the second power supply voltage VSS is a negative voltage. FIG. 9 is a schematic diagram of a structure of another pixel circuit according to an embodiment of the present application. Referring to FIG. 9, the pixel circuit further includes a first initialization module 180, where a control terminal of the first initialization module 180 is connected to a third control signal line, the third control signal line being configured to transmit a third control signal GC3, a first terminal of the first initialization module 180 is connected to a first initialization signal line L4, a second terminal of the first initialization module 180 is connected to the second terminal of the driving module 110, and the first initialization module 180 is configured to transmit, in the initialization phase, a first initialization voltage Vint1 on the first initialization signal line L4 to the control terminal of the driving module 110 through the compensation module, thereby initializing the first terminal of the light-emitting module 140 while initializing the control terminal of the driving module 110.

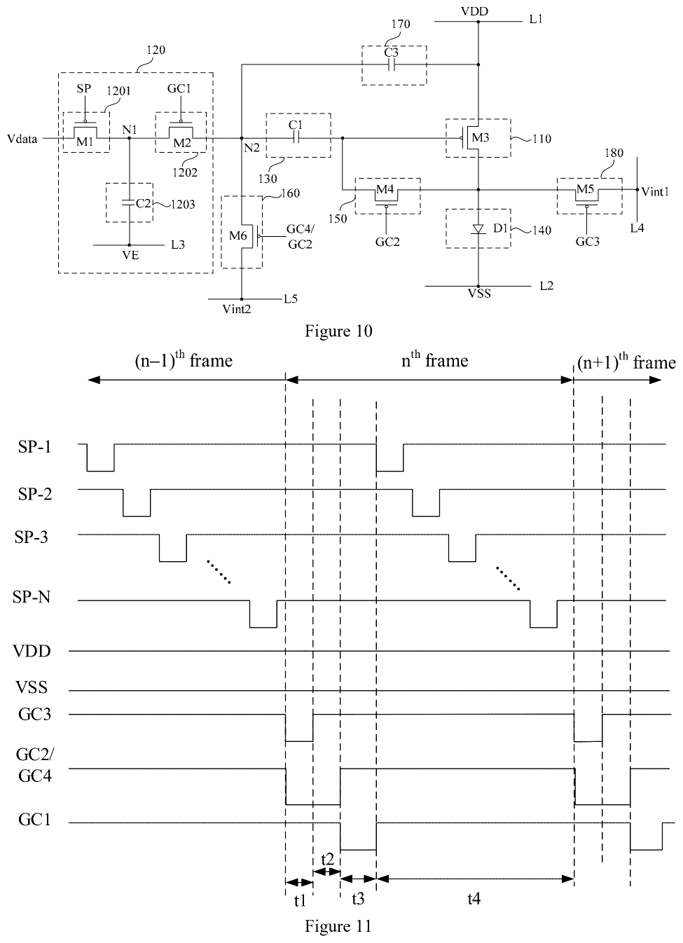

FIG. 10 is a schematic diagram of a structure of another pixel circuit according to an embodiment of the present application, which is specifically a schematic diagram of the pixel circuit shown in FIG. 9 that is refined into a device structure. Referring to FIG. 10, the first initialization module 180 includes a fifth transistor M5, where a gate of the fifth transistor M5 is connected to the third control signal line, a first electrode of the fifth transistor M5 is connected to the first initialization signal line L4, and a second electrode of the fifth transistor M5 is connected to the second electrode of the third transistor M3. For a connection relationship between the other transistors, reference may be made to the related descriptions of FIG. 4.

FIG. 11 is a schematic diagram of driving timing of another pixel circuit provided in an embodiment of the present application, which is applicable to the pixel circuit described in FIG. 10. Descriptions are provided still by using an example in which each transistor is a P-type transistor. With reference to FIG. 10 and FIG. 11, the operating process of the pixel circuit provided in this embodiment within a frame includes an initialization phase t1, a compensation phase t2, a data writing phase t3, and a light emission phase t4 in sequence. The first power supply voltage VDD is at a high level, and the second power supply voltage VSS is at a low level.

The operating process in the light emission phase of the (n−1)^{th} frame (i.e., the first writing phase) is the same as the operating process of the pixel circuit shown in FIG. 4 in the light emission phase of the (n−1)^{th} frame.

In the nth frame:
in the initialization phase t1, the scan signal SP is at a high level, the first control signal GC1 is at a high level, the second control signal GC2 and the fourth control signal GC4 are both at a low level, and the third control signal GC3 is at a low level. Therefore, the fourth transistor M4, the fifth transistor M5, and the sixth transistor M6 are turned on. The second initialization voltage Vint2 on the second initialization signal line L5 is transmitted to the second node N2 through the sixth transistor M6, to stabilize a potential at the second node N2. The first initialization voltage Vint1 on the first initialization signal line L4 is transmitted to the first electrode of the light-emitting diode D1 through the fifth transistor M5 and to the gate of the third transistor M3 through the fourth transistor M4, to implement initialization of the first electrode of the light-emitting diode D1 and the gate of the third transistor M3.

In the compensation phase t2, the scan signal SP is at a high level, the first control signal GC1 is at a high level, the second control signal GC2 and the fourth control signal GC4 are both at a low level, and the third control signal GC3 is at a high level. Therefore, the fourth transistor M4 and the sixth transistor M6 remain turned on. The second initialization voltage Vint2 on the second initialization signal line L5 is transmitted to the second node N2 through the sixth transistor M6, to maintain a stable voltage on the second node N2. The first power supply voltage VDD charges the gate of the third transistor M3 through the third transistor M3 and the fourth transistor M4. When the voltage at the gate of the third transistor M3 reaches VDD+Vth3, the third transistor M3 is turned off, thereby implementing compensation for a threshold voltage of the third transistor M3. Vth3 is the threshold voltage of the third transistor M3.

In the data writing phase t3 (the second writing phase), the second power supply voltage VSS is at a low level, and the specific operating process of the pixel circuit is the same as the operating process of the pixel circuit shown in FIG. 4 in the data writing phase t3.

The operating process of the pixel circuit in the light emission phase t4 is the same as the operating process of the pixel circuit shown in FIG. 4 in the light emission phase t4.

This embodiment also has the beneficial effects described in any one of the above embodiments, which will not be repeated.

FIG. 12 is a schematic diagram of a structure of another pixel circuit according to an embodiment of the present application. Referring to FIG. 12, a difference between the pixel circuit in this figure and the pixel circuit shown in FIG. 10 lies in a connection relationship of the second storage unit 170 (i.e., the third capacitor C3). Here, the first terminal of the second storage unit 170 is connected to the first terminal of the driving module 110, the second terminal of the second storage unit 170 is connected to the control terminal of the driving module 110, and the second storage unit 170 is configured to store a voltage at the control terminal of the driving module 110.

The operating process of the pixel circuit shown in FIG. 12 is similar to the operating process of the pixel circuit shown in FIG. 10, only except for a change in a voltage at part of the nodes. The driving timing shown in FIG. 11 is applicable to both the operating processes. Details are not described herein.

In one embodiment, in the pixel circuits shown in FIG. 10 and FIG. 12, at least part of the transistors other than the third transistor M3 may also be N-type transistors.

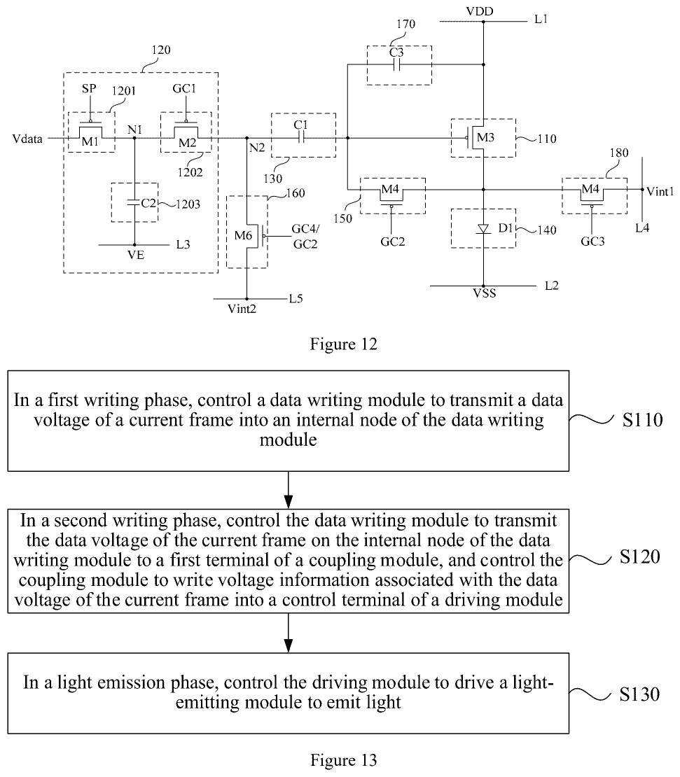

An embodiment of the present application further provides a driving method for a pixel circuit. The driving method may be used to drive the pixel circuit provided in any one of the above embodiments. FIG. 13 is a flowchart of a driving method for a pixel circuit according to an embodiment of the present application. Referring to FIG. 13, the driving method for a pixel circuit includes the following steps.

S110: In a first writing phase, control a data writing module to transmit a data voltage of a current frame to an internal node of the data writing module.

S120: In a second writing phase, control the data writing module to transmit the data voltage of the current frame on the internal node of the data writing module to a first terminal of a coupling module, and control the coupling module to write voltage information associated with the data voltage of the current frame into a control terminal of a driving module.

S130: In a light emission phase, control the driving module to drive a light-emitting module to emit light.

In this embodiment of the present application, the data voltage is transmitted to the first terminal of the coupling module in different phases, to write the data voltage corresponding to the current frame into the internal node during the previous frame, and transmit the data voltage on the internal node to the first terminal of the coupling module during the current frame, which can implement writing of the data voltage of the current frame in a phase in the previous frame, and reduce a data writing time within a frame, thereby shortening a row time to implement display at a high refresh rate.

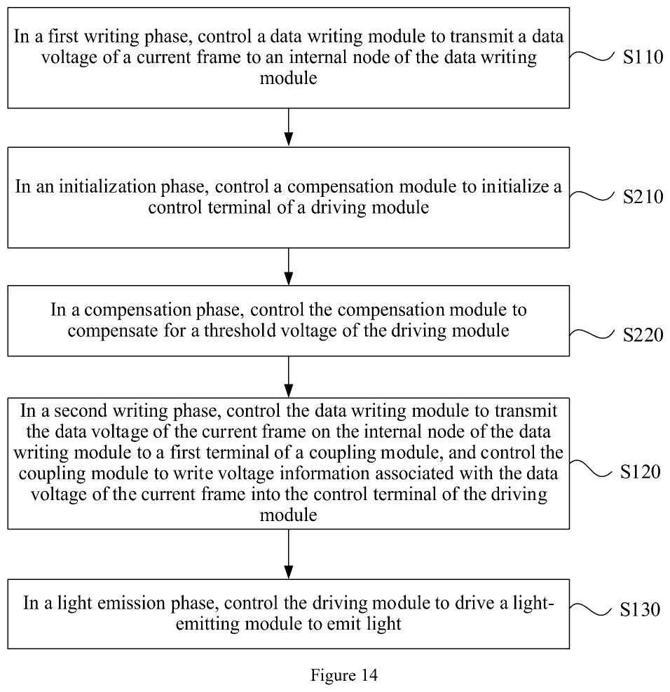

FIG. 14 is a flowchart of a driving method for another pixel circuit according to an embodiment of the present application. With reference to FIG. 3 and FIG. 14, the pixel circuit further includes a compensation module 150. The compensation module 150 is connected between the control terminal and the second terminal of the driving module 110. The driving method for another pixel circuit provided in this embodiment includes the following steps.

S110: In a first writing phase, control a data writing module to transmit a data voltage of a current frame to an internal node of the data writing module.

S210: In an initialization phase, control the compensation module to initialize the control terminal of the driving module.

S220: In a compensation phase, control the compensation module to compensate for a threshold voltage of the driving module.

S120: In a second writing phase, control the data writing module to transmit the data voltage of the current frame on the internal node of the data writing module to a first terminal of a coupling module, and control the coupling module to write voltage information associated with the data voltage of the current frame into the control terminal of the driving module.

S130: In a light emission phase, control the driving module to drive a light-emitting module to emit light.

Specifically, within a frame, the initialization phase, the compensation phase, the second writing phase, and the light emission phase are included in sequence. The first writing phase is a light emission phase of a previous frame, the second writing phase is a data writing phase of the current frame, and the initialization phase and the compensation phase are between the first writing phase and the second writing phase.

In this embodiment, the first power supply voltage VDD transmitted on the first power supply line L1 is a variable signal, and the second power supply voltage VSS transmitted on the second power supply line L2 is a variable signal. For example, the first power supply voltage VDD includes a first potential and a second potential, and the second power supply voltage VSS includes a third potential and a fourth potential. The first power supply voltage VDD transmitted on the first power supply line L1 is a variable signal, and the second power supply voltage VSS transmitted on the second power supply line L2 is a variable signal. For example, the first power supply voltage VDD includes a first potential and a second potential, and the second power supply voltage VSS includes a third potential and a fourth potential.

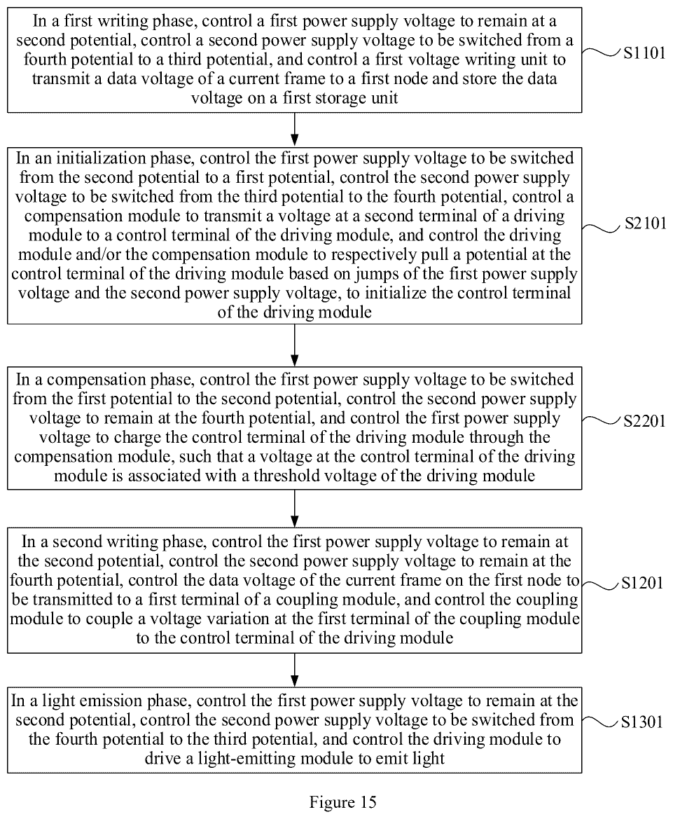

FIG. 15 is a flowchart of a driving method for another pixel circuit according to an embodiment of the present application. With reference to FIG. 3 and FIG. 15, the data writing module 120 includes a first voltage writing unit 1201, a second voltage writing unit 1202, and a first storage unit 1203. A first terminal of the first voltage writing unit 1201 is connected to a data line, a second terminal of the first voltage writing unit 1201 and a first terminal of the second voltage writing unit 1202 are connected to a first node N1, a second terminal of the second voltage writing unit 1202 is connected to the first terminal of the coupling module 130, a control terminal of the first voltage writing unit 1201 is connected to a scan signal line, a control terminal of the second voltage writing unit 1202 is connected to a first control signal line, and the first storage unit 1203 is connected between a fixed signal line L3 and the first node N1. The driving method for a pixel circuit provided in this embodiment includes the following steps.

S1101: In a first writing phase, control a first power supply voltage to remain at a second potential, control a second power supply voltage to be switched from a fourth potential to a third potential, and control the first voltage writing unit to transmit a data voltage of a current frame to a first node and store the data voltage on a first storage unit.

Specifically, the first writing phase is a light emission phase of a previous frame. In the light emission phase of the previous frame, for example, a light emission phase of an (n−1)^{th} frame, the first voltage writing unit 1201 is controlled to be turned on in response to the scan signal SP, the second voltage writing unit 1202 is controlled to be turned off in response to the first control signal GC1, and a data voltage Vdata of an nth frame transmitted on the data line is written into the first node N1 and stored on the first storage unit 1203.

S2101: In an initialization phase, control the first power supply voltage to be switched from the second potential to a first potential, control the second power supply voltage to be switched from the third potential to the fourth potential, control a compensation module to transmit a voltage at a second terminal of a driving module to a control terminal of the driving module, and control at least one of the driving module and the compensation module to respectively pull a potential at the control terminal of the driving module based on jumps of the first power supply voltage and the second power supply voltage, to initialize the control terminal of the driving module.

Specifically, in the initialization phase, the compensation module 150 is turned on, and the first voltage writing unit 1201 and the second voltage writing unit 1202 are turned off. The first power supply voltage VDD is switched from the second potential at the high level to the first potential at the low level, and the voltage at the first terminal of the driving module 110 decreases. The second power supply voltage VSS is switched from the third potential at the low level to the fourth potential at the high level, and the voltage at the second terminal of the driving module 110 increases. The second terminal of the driving module 110 leaks current to the first power supply line L1, and the voltage at the second terminal of the driving module 110 decreases. Since the compensation module 150 is turned on, the control terminal and the second terminal of the driving module 110 are at the same potential, and the potential at the control terminal of the driving module 110 decreases. Moreover, since the first power supply voltage VDD is switched from the high level to the low level, the potential at the control terminal of the driving module 110 synchronously decreases under the effect of coupling of a parasitic capacitance in the driving module 110, thereby implementing initialization of the potential at the control terminal of the driving module 110.

In addition, since the second control signal GC2 connected to the control terminal of the compensation module 150 is switched from a turn-off level to a turn-on level, such as from a high level to a low level, the potential at the control terminal of the driving module 110 is pulled down under the effect of coupling of the parasitic capacitance in the compensation module 150, to enable further initialization of the potential at the control terminal of the driving module 110, thereby ensuring an initialization effect.

S2201: In a compensation phase, control the first power supply voltage to be switched from the first potential to the second potential, control the second power supply voltage to remain at the fourth potential, and control the first power supply voltage to charge the control terminal of the driving module through the compensation module, and a voltage at the control terminal of the driving module is associated with the threshold voltage of the driving module.

Specifically, in the compensation phase, the compensation module 150 is turned on, and the first voltage writing unit 1201 and the second voltage writing unit 1202 are turned off. The first power supply voltage VDD is switched to the high level, the second power supply voltage VSS remains at the high level in the initialization phase, and the first power supply voltage VDD charges the control terminal of the driving module 110 through the compensation module 150. When a potential difference between the control terminal and the first terminal of the driving module 150 is equal to the threshold voltage of the driving module 110, the driving module 110 is turned off, and the compensation phase ends.

S1201: In a second writing phase, control the first power supply voltage to remain at the second potential, control the second power supply voltage to remain at the fourth potential, control the data voltage of the current frame on the first node to be transmitted to a first terminal of a coupling module, and control the coupling module to couple a voltage variation at the first terminal of the coupling module to the control terminal of the driving module.

Specifically, in the second writing phase, i.e., the data writing phase, the compensation module 150 and the first voltage writing unit 1201 are turned off, and the second voltage writing unit 1202 is turned on. The data voltage Vdata of the current frame stored on the first node N1 in the previous frame is written into the first terminal of the coupling module 130 through the second voltage writing unit 1202, and the data voltage Vdata of the current frame is directly coupled to the control terminal of the driving module 110 under the effect of coupling of the coupling module 130, thereby implementing data writing.

S1301: In a light emission phase, control the first power supply voltage to remain at the second potential, control the second power supply voltage to be switched from the fourth potential to the third potential, and control the driving module to drive a light-emitting module to emit light.

Specifically, in the light emission phase, the compensation module 150 and the second voltage writing unit 1202 are turned off, and the first voltage writing unit 1201 and the driving module 110 are turned on. The driving module 110 is controlled to drive the light-emitting module 140 to emit light based on voltage information including the data voltage Vdata of the current frame at the control terminal of the driving module. In addition, the first voltage writing unit 1201 is controlled to write the data voltage Vdata of the next frame into the first node N1, to write the data voltage Vdata of the next frame while implementing light emission in the current frame. In addition, a data writing time does not affect a light emission time of the light-emitting module 140. Therefore, the method is applicable to a scenario with a high refresh rate.

In this embodiment of the present application, the first power supply voltage VDD and the second power supply voltage VSS are set as variable signals, and the first supply switching voltage VDD and the second power supply voltage VSS are switched to implement initialization of the driving module 110 and compensation for the threshold voltage of the driving module, which eliminates the need to provide a light emission control module, thereby simplifying the circuit structure. In addition, since the compensation phase is separate from the data writing phase (the second writing phase) in terms of time, the time for the threshold voltage compensation is not limited by a row time, and full compensation for the threshold voltage of the driving module 110 can be implemented even at a high refresh rate. Therefore, a difference between characteristics of the driving module 110 at different pixels and different gray scales can be reduced, thereby facilitating mitigation of variations in display brightness and an improvement in the uniformity of display quality.

In this embodiment, a sum of times of the initialization phase, the compensation phase, and the second writing phase is less than the row time, which enables a higher degree of initialization of the control terminal of the driving module 110 and a higher degree of compensation for the threshold voltage, thereby facilitating an improvement in the display effect.

In one embodiment, the pixel circuit further includes a second initialization module 160. The second initialization module 160 is connected between the second initialization signal line L5 and the first terminal of the coupling module 130. In the initialization phase and the compensation phase, the driving method for a pixel circuit further includes:
controlling the second initialization module to transmit a second initialization voltage on the second initialization signal line to the first terminal of the coupling module.

The second initialization voltage Vint2 is written into the first terminal of the coupling module 130 (i.e., the second node N2) to maintain the potential at the second node N2, thereby ensuring smooth operation of the initialization and the threshold voltage compensation, and enabling a stable potential at the control terminal of the driving module 110.

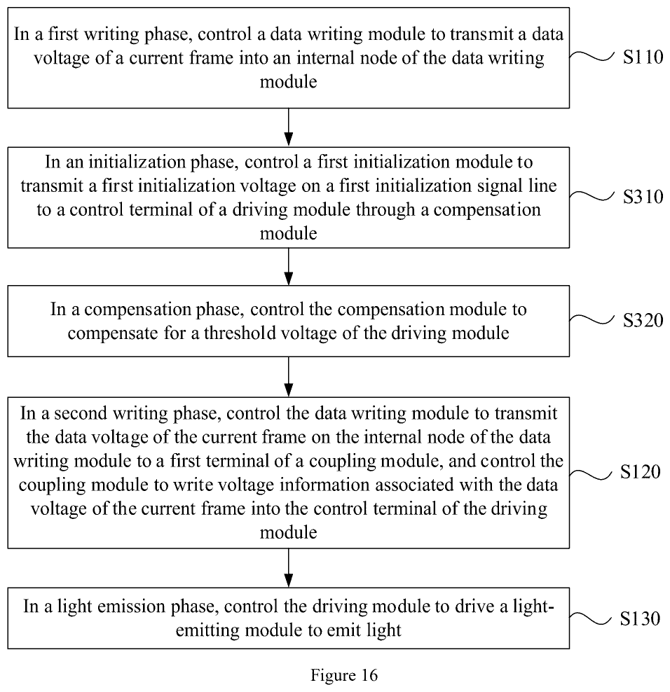

FIG. 16 is a flowchart of a driving method for another pixel circuit according to an embodiment of the present application. With reference to FIG. 9 and FIG. 16, in another optional implementation provided for this embodiment, the pixel circuit further includes a compensation module 150 and a first initialization module 180. The compensation module 150 is connected between the control terminal and the second terminal of the driving module 110, and the first initialization module 180 is connected between the first initialization signal line L4 and the second terminal of the driving module 110. The driving method for another pixel circuit provided in this embodiment includes the following steps.

S110: In a first writing phase, control a data writing module to transmit a data voltage of a current frame to an internal node of the data writing module.

S310: In an initialization phase, control the first initialization module to transmit a first initialization voltage on the first initialization signal line to the control terminal of the driving module through the compensation module.

S320: In a compensation phase, control the compensation module to compensate for a threshold voltage of the driving module.

S120: In a second writing phase, control the data writing module to transmit the data voltage of the current frame on the internal node of the data writing module to a first terminal of a coupling module, and control the coupling module to write voltage information associated with the data voltage of the current frame into the control terminal of the driving module.

S130: In a light emission phase, control the driving module to drive a light-emitting module to emit light.

For the specific operating process of the driving method for a pixel circuit shown in FIG. 16, reference may be made to the related descriptions of FIG. 9 in the above embodiment. Details are not described herein.

In one embodiment, on the basis of the above embodiments, the driving method for a pixel circuit provided in this embodiment further includes: controlling, in a start frame, the light-emitting module to be displayed at a black state.

Specifically, the data voltage Vdata of the current frame is written into the first node N1 in the light emission phase of the previous frame, but there is no previous frame for the start frame (i.e., the first frame), that is, it is not possible to write a corresponding data voltage Vdata in the start frame. Therefore, in this embodiment, it is possible to control black-state display in the start frame, to avoid a display error. In the case of a high refresh rate, since a row time is so short that human eyes cannot distinguish the visual effect of the start frame, black-state display in the start frame has no adverse impact on the entire display process.

In one embodiment, the first power supply voltage VDD may be pulled down or the second power supply voltage VSS may be pulled up, and a difference between the first power supply voltage VDD and the second power supply voltage VSS is less than a turn-on voltage of the light-emitting module 140 to control the light-emitting module to be displayed at a black state.

An embodiment of the present application further provides a display panel. The display panel includes the pixel circuit provided in any one of the embodiments of the present application. Therefore, the display panel also has the beneficial effects described in any one of the above embodiments.

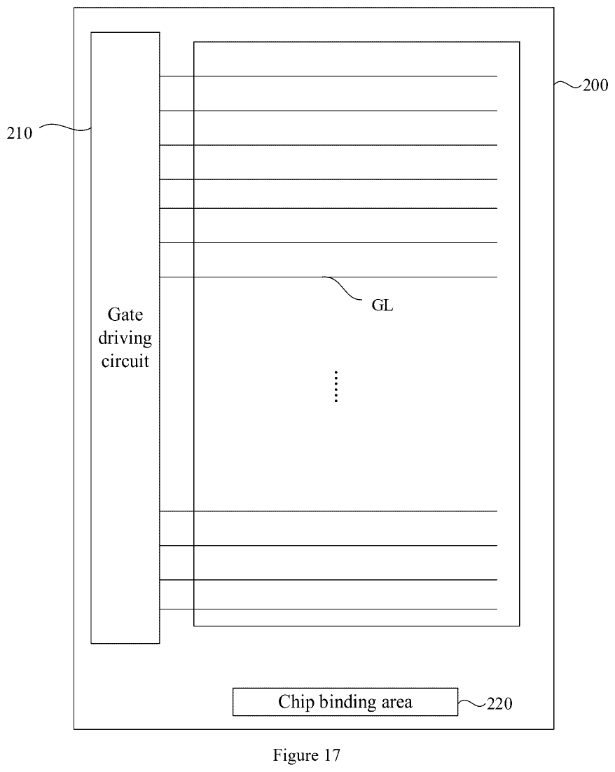

FIG. 17 is a schematic diagram of a structure of a display panel according to an embodiment of the present application. Referring to FIG. 3 and FIG. 17, the display panel 200 provided in this embodiment includes a gate driving circuit 210 and a plurality of scan signal lines GL. The gate driving circuit 210 is connected to the plurality of scan signal lines GL. The gate driving circuit 210 is configured to output a scan signal SP through the scan signal lines GL stage by stage. Each scan signal line GL is correspondingly connected to control terminals of first voltage writing units 1201 in one row of pixel circuits, and the plurality of scan signal lines GL are configured to transmit the scan signal SP to the control terminal of the first voltage writing unit 1201 of the pixel circuit row by row.

In one embodiment, the display panel further includes a plurality of first control signal lines and a plurality of second control signal lines (not shown in the figure). The control terminal of the second voltage writing unit 1202 is connected to the first control signal lines, and the control terminal of the second initialization module 160 and the control terminal of the compensation module 150 are both connected to the second control signal lines. Here, the second control signal line is reused as the fourth control signal line, to reduce the number of signal lines, thereby facilitating an improvement in the PPI. Each row of pixel circuits is connected to one first control signal line and one second control signal line, respectively. The plurality of second control signal lines are configured to simultaneously transmit a second control signal GC2 to the compensation modules 150 and the initialization modules of all rows of pixel circuits, and the plurality of first control signal lines are configured to simultaneously transmit a first control signal GC1 to the second voltage writing units 1202 of all rows of pixel circuits, thereby implementing full-screen initialization, threshold voltage compensation, and data writing processes.

In one embodiment, the display panel provided in this embodiment further includes a chip binding area 220. The chip binding area 220 is configured to bind a driver chip. The plurality of first control signal lines and the plurality of second control signal lines are respectively connected to the chip binding area 220, to provide the corresponding first control signal GC1 and second control signal GC2 through the driver chip provided in the chip binding area 220. Therefore, in this embodiment, only one set of gate driving circuits 210 is required, which facilitates the implementation of a narrow-bezel effect of the display panel 200.

In this embodiment, the display panel 200 may be applied to a mobile phone, or may be applied to any electronic product with a display function, including but not limited to: a television, a notebook computer, a desktop monitor, a tablet computer, a digital camera, a smart bracelet, smart glasses, a vehicle-mounted display, a medical device, an industrial control device, a touch interactive terminal, etc., which is not specifically limited in this embodiment of the present application.

With the various forms of processes shown above, the steps may be reordered, added, or deleted. For example, the steps recorded in the present application may be performed in parallel, sequentially, or in a different order, provided that desired results of the embodiments of the present application can be achieved, which are not limited herein.

1. A pixel circuit, comprising:
a driving module configured to drive, in a light emission phase, a light-emitting module to emit light;
a coupling module, wherein a second terminal of the coupling module is connected to a control terminal of the driving module; and
a data writing module connected to a first terminal of the coupling module and configured to transmit a data voltage to the first terminal of the coupling module in different phases, and write voltage information associated with the data voltage into the control terminal of the driving module through the coupling module.

2. The pixel circuit according to claim 1, wherein the data writing module is configured to transmit a data voltage of a current frame to an internal node of the data writing module in a light emission phase of a previous frame, and transmit the data voltage of the current frame on the internal node of the data writing module to the first terminal of the coupling module in a data writing phase of the current frame.

3. The pixel circuit according to claim 1, wherein the data writing module comprises a first voltage writing unit, a second voltage writing unit, and a first storage unit,
wherein a first terminal of the first voltage writing unit is connected to a data line, a second terminal of the first voltage writing unit and a first terminal of the second voltage writing unit are connected to a first node, a second terminal of the second voltage writing unit is connected to the first terminal of the coupling module, a control terminal of the first voltage writing unit is connected to a scan signal line, a control terminal of the second voltage writing unit is connected to a first control signal line, and the first storage unit is connected between a fixed signal line and the first node;
the first voltage writing unit is configured to write the data voltage of the current frame into the first node in the light emission phase of the previous frame, and the second voltage writing unit is configured to transmit the data voltage of the current frame on the first node to the first terminal of the coupling module in the data writing phase of the current frame;
the internal node of the data writing module comprises the first node;
the driving module and the light-emitting module are connected in series between a first power supply line and a second power supply line, the first power supply line being reused as the fixed signal line;
the first voltage writing unit comprises a first transistor, the second voltage writing unit comprises a second transistor, the coupling module comprises a first capacitor, and the first storage unit comprises a second capacitor; and
a first electrode of the first transistor is connected to the data line, a second electrode of the first transistor is connected to the first node, a gate of the first transistor is connected to the scan signal line, a first electrode of the second transistor is connected to the first node, a second electrode of the second transistor is connected to a first electrode of the first capacitor, a second electrode of the first capacitor is connected to the control terminal of the driving module, a gate of the second transistor is connected to the first control signal line, a first electrode of the second capacitor is connected to the fixed signal line, and a second electrode of the second capacitor is connected to the first node.

4. The pixel circuit according to claim 1, wherein the pixel circuit further comprises a compensation module connected to the driving module and configured to initialize the control terminal of the driving module in an initialization phase and compensate for a threshold voltage of the driving module in a compensation phase.

5. The pixel circuit according to claim 4, wherein the first terminal of the driving module is connected to a first power supply line, a second terminal of the driving module is connected to a first terminal of the light-emitting module, and a second terminal of the light-emitting module is connected to a second power supply line, and
a first power supply voltage transmitted on the first power supply line being a variable signal, and a second power supply voltage transmitted on the second power supply line being a variable signal;
the compensation module is connected between the control terminal and the second terminal of the driving module, and a control terminal of the compensation module is connected to a second control signal line; and
the driving module comprises a third transistor, the compensation module comprises a fourth transistor, the light-emitting module comprises a light-emitting diode, a first electrode of the third transistor is connected as the first terminal of the driving module to the first power supply line, a second electrode of the third transistor is connected as the second terminal of the driving module to a first electrode of the light-emitting diode, a second electrode of the light-emitting diode is connected to the second power supply line, a first electrode of the fourth transistor is connected to the second electrode of the third transistor, a second electrode of the fourth transistor is connected to a gate of the third transistor, and a gate of the fourth transistor is connected to the second control signal line.

6. The pixel circuit according to claim 5, wherein the first power supply voltage comprises a first potential and a second potential, and the second power supply voltage comprises a third potential and a fourth potential; and
in the initialization phase, the first power supply voltage is configured to be switched from the second potential to the first potential, the second power supply voltage is configured to be switched from the third potential to the fourth potential, and the compensation module is configured to pull a potential at the control terminal of the driving module in the initialization phase based on the first power supply voltage having the first potential and the second power supply voltage having the fourth potential, to initialize the control terminal of the driving module,
wherein the first potential is less than the second potential, the third potential is less than the fourth potential, and a voltage difference between the first potential and the fourth potential is less than a turn-on voltage of the light-emitting module;
the first potential and the third potential are negative values, and the second potential and the fourth potential are positive values; and
the initialized potential at the control terminal of the driving module is less than the second potential of the first power supply voltage.

7. The pixel circuit according to claim 6, wherein in the compensation phase, the first power supply voltage is configured to be switched from the first potential to the second potential, the second power supply voltage is configured to remain at the fourth potential, and the compensation module is configured to compensate for the threshold voltage of the driving module in the compensation phase based on the first power supply voltage having the second potential;
an initialization phase of a current frame is before a compensation phase of the current frame and after a light emission phase of a previous frame; and
a data writing phase of the current frame is after the compensation phase of the current frame and before a light emission phase of the current frame.

8. The pixel circuit according to claim 1, wherein the pixel circuit further comprises a compensation module connected between the control terminal and a second terminal of the driving module, wherein a control terminal of the compensation module is connected to a second control signal line, and the compensation module is configured to compensate for a threshold voltage of the driving module in a compensation phase;
the pixel circuit further comprises a first initialization module, wherein a control terminal of the first initialization module is connected to a third control signal line, a first terminal of the first initialization module is connected to a first initialization signal line, a second terminal of the first initialization module is connected to the second terminal of the driving module, and the first initialization module is configured to transmit a first initialization voltage on the first initialization signal line to the control terminal of the driving module through the compensation module in an initialization phase;
an initialization phase of a current frame is before a compensation phase of the current frame and after a light emission phase of a previous frame; and
a data writing phase of the current frame is after the compensation phase of the current frame and before a light emission phase of the current frame;
the first terminal of the driving module is connected to a first power supply line, the second terminal of the driving module is connected to a first terminal of the light-emitting module, and a second terminal of the light-emitting module is connected to a second power supply line; and
the driving module comprises a third transistor, the compensation module comprises a fourth transistor, the first initialization module comprises a fifth transistor, and the light-emitting module comprises a light-emitting diode, wherein a first electrode of the third transistor is connected as the first terminal of the driving module to the first power supply line, a second electrode of the third transistor is connected as the second terminal of the driving module to a first electrode of the light-emitting diode, a second electrode of the light-emitting diode is connected to the second power supply line, a first electrode of the fourth transistor is connected to the second electrode of the third transistor, a second electrode of the fourth transistor is connected to a gate of the third transistor, and a gate of the fourth transistor is connected to the second control signal line; a first electrode of the fifth transistor is connected to the first initialization signal line, a second electrode of the fifth transistor is connected to the second electrode of the third transistor, and a gate of the fifth transistor is connected to the third control signal line;
a first power supply voltage transmitted on the first power supply line is a fixed signal, and a second power supply voltage transmitted on the second power supply line is a fixed signal; and
the first power supply voltage is greater than the second power supply voltage.

9. The pixel circuit according to claim 5, wherein the pixel circuit further comprises a second initialization module connected between a second initialization signal line and the first terminal of the coupling module, wherein a control terminal of the second initialization module is connected to a fourth control signal line or the second control signal line, and the second initialization module is configured to transmit a second initialization voltage on the second initialization signal line to the first terminal of the coupling module in the initialization phase and the compensation phase; and
the second initialization module comprises a sixth transistor, wherein a gate of the sixth transistor is connected to the fourth control signal line or the second control signal line, a first electrode of the sixth transistor is connected to the second initialization signal line, and a second electrode of the sixth transistor is connected to the first terminal of the coupling module.

10. The pixel circuit according to claim 1, wherein the pixel circuit further comprises a second storage unit, wherein a first terminal of the second storage unit is connected to the first terminal of the driving module, and a second terminal of the second storage unit is connected to the first terminal of the coupling module; and
the second storage unit comprises a third capacitor, wherein a first electrode of the third capacitor is connected to the first terminal of the driving module, and a second electrode of the third capacitor is connected to the first terminal of the coupling module.

11. The pixel circuit according to claim 1, wherein the pixel circuit further comprises a second storage unit, wherein a first terminal of the second storage unit is connected to the first terminal of the driving module, and a second terminal of the second storage unit is connected to the control terminal of the driving module; and
the second storage unit comprises a third capacitor, wherein a first electrode of the third capacitor is connected to the first terminal of the driving module, and a second electrode of the third capacitor is connected to the control terminal of the driving module.

12. A driving method for a pixel circuit, wherein the pixel circuit comprises a driving module, a data writing module, a coupling module, and a light-emitting module, the data writing module being connected to a first terminal of the coupling module, and a second terminal of the coupling module being connected to a control terminal of the driving module,
the driving method for a pixel circuit comprising:
in a first writing phase, controlling the data writing module to transmit a data voltage of a current frame to an internal node of the data writing module;
in a second writing phase, controlling the data writing module to transmit the data voltage of the current frame on the internal node of the data writing module to the first terminal of the coupling module, and controlling the coupling module to write voltage information associated with the data voltage of the current frame into the control terminal of the driving module; and
in a light emission phase, controlling the driving module to drive the light-emitting module to emit light.

13. The driving method for a pixel circuit according to claim 12, wherein the pixel circuit further comprises a compensation module connected between the control terminal and a second terminal of the driving module; and
wherein the driving method for a pixel circuit further comprises:
in an initialization phase, controlling the compensation module to initialize the control terminal of the driving module; and
in a compensation phase, controlling the compensation module to compensate for a threshold voltage of the driving module,
wherein within a frame, the initialization phase, the compensation phase, the second writing phase, and the light emission phase are included in sequence, wherein the first writing phase is a light emission phase of a previous frame, the second writing phase is a data writing phase of a current frame, and
the initialization phase and the compensation phase are between the first writing phase and the second writing phase.

14. The driving method for a pixel circuit according to claim 13, wherein a first terminal of the driving module is connected to a first power supply line, a second terminal of the driving module is connected to a first terminal of the light-emitting module, and a second terminal of the light-emitting module is connected to a second power supply line; and a first power supply voltage transmitted on the first power supply line comprises a first potential and a second potential, and a second power supply voltage transmitted on the second power supply line comprises a third potential and a fourth potential; and
wherein the driving method for a pixel circuit comprises:
in the initialization phase, controlling the first power supply voltage to be switched from the second potential to the first potential, controlling the second power supply voltage to be switched from the third potential to the fourth potential, controlling the compensation module to transmit a voltage at the second terminal of the driving module to the control terminal of the driving module, and controlling at least one of the driving module and the compensation module to respectively pull a potential at the control terminal of the driving module based on jumps of the first power supply voltage and the second power supply voltage, to initialize the control terminal of the driving module; and
in the compensation phase, controlling the first power supply voltage to be switched from the first potential to the second potential, controlling the second power supply voltage to remain at the fourth potential, and controlling the first power supply voltage to charge the control terminal of the driving module through the compensation module, and a voltage at the control terminal of the driving module is associated with the threshold voltage of the driving module,
wherein the first potential is less than the second potential, the third potential is less than the fourth potential, and a voltage difference between the first potential and the fourth potential is less than a turn-on voltage of the light-emitting module.

15. The driving method for a pixel circuit according to claim 14, wherein the data writing module comprises a first voltage writing unit, a second voltage writing unit, and a first storage unit, wherein a first terminal of the first voltage writing unit is connected to a data line, a second terminal of the first voltage writing unit and a first terminal of the second voltage writing unit are connected to a first node, a second terminal of the second voltage writing unit is connected to a first terminal of the coupling module, a control terminal of the first voltage writing unit is connected to a scan signal line, a control terminal of the second voltage writing unit is connected to a first control signal line, and the first storage unit is connected between a fixed signal line and the first node;
wherein the driving method for a pixel circuit comprises:
in the first writing phase, controlling the first power supply voltage to remain at the second potential, controlling the second power supply voltage to be switched from the fourth potential to the third potential, and controlling the first voltage writing unit to transmit the data voltage of the current frame to the first node and store the data voltage on the first storage unit; and
in the second writing phase, controlling the first power supply voltage to remain at the second potential, controlling the second power supply voltage to remain at the fourth potential, controlling the data voltage of the current frame on the first node to be transmitted to the first terminal of the coupling module, and controlling the coupling module to couple a voltage variation at the first terminal of the coupling module to the control terminal of the driving module; and
wherein the driving method for a pixel circuit further comprises:
in the light emission phase, controlling the first power supply voltage to remain at the second potential, controlling the second power supply voltage to be switched from the fourth potential to the third potential, and controlling the driving module to drive the light-emitting module to emit light,
wherein a sum of times of the initialization phase, the compensation phase, and the second writing phase is less than a row time;
in the initialization phase, the compensation module is turned on, and the first voltage writing unit and the second voltage writing unit are turned off;
in the compensation phase, the compensation module is turned on, and the first voltage writing unit and the second voltage writing unit are turned off;
in the second writing phase, the compensation module and the first voltage writing unit are turned off, and the second voltage writing unit is turned on; and
in the first writing phase and the light emission phase, the compensation module and the second voltage writing unit are turned off, and the first voltage writing unit and the driving module are turned on.

16. The driving method for a pixel circuit according to claim 13, wherein the pixel circuit further comprises a second initialization module connected between a second initialization signal line and the first terminal of the coupling module; and
wherein in the initialization phase and the compensation phase, the driving method for a pixel circuit further comprises:
controlling the second initialization module to transmit a second initialization voltage on the second initialization signal line to the first terminal of the coupling module.

17. The driving method for a pixel circuit according to claim 12, wherein the pixel circuit further comprises a compensation module and a first initialization module, wherein the compensation module is connected between the control terminal and a second terminal of the driving module, and the first initialization module is connected between a first initialization signal line and a second terminal of the driving module; and
wherein the driving method for a pixel circuit further comprises:
in an initialization phase, controlling the first initialization module to transmit a first initialization voltage on the first initialization signal line to the control terminal of the driving module through the compensation module; and
in a compensation phase, controlling the compensation module to compensate for a threshold voltage of the driving module,
wherein a first terminal of the driving module is connected to a first power supply line, the second terminal of the driving module is connected to a first terminal of the light-emitting module, a second terminal of the light-emitting module is connected to a second power supply line, and a first power supply voltage transmitted on the first power supply line and a second power supply voltage transmitted on the second power supply line are both direct current voltages;
the first power supply voltage is greater than the second power supply voltage; and
within a frame, the initialization phase, the compensation phase, the second writing phase, and the light emission phase are included in sequence, wherein the first writing phase is a light emission phase of a previous frame, the second writing phase is a data writing phase of a current frame, and
the initialization phase and the compensation phase are between the first writing phase and the second writing phase.

18. The driving method for a pixel circuit according to claim 12, wherein the driving method for a pixel circuit further comprises:
controlling, in a start frame, the light-emitting module to be displayed at a black state.

19. A display panel, comprising:
a pixel circuit, comprising:
a driving module configured to drive, in a light emission phase, a light-emitting module to emit light;
a coupling module, wherein a second terminal of the coupling module is connected to a control terminal of the driving module; and
a data writing module connected to a first terminal of the coupling module and configured to transmit a data voltage to the first terminal of the coupling module in different phases, and write voltage information associated with the data voltage into the control terminal of the driving module through the coupling module.

20. The display panel according to claim 19, wherein the display panel further comprises a plurality of scan signal lines, a plurality of first control signal lines, and a plurality of second control signal lines, and the pixel circuit further comprises a second initialization module and a compensation module, wherein the second initialization module is connected between a second initialization signal line and the first terminal of the coupling module, and the compensation module is connected between a second terminal and the control terminal of the driving module; the data writing module comprises a first voltage writing unit, a second voltage writing unit, and a first storage unit, wherein a first terminal of the first voltage writing unit is connected to a data line, a second terminal of the first voltage writing unit and a first terminal of the second voltage writing unit are connected to a first node, a second terminal of the second voltage writing unit is connected to the first terminal of the coupling module, a control terminal of the first voltage writing unit is connected to a scan signal line, a control terminal of the second voltage writing unit is connected to a first control signal line, and the first storage unit is connected between a fixed signal line and the first node; a control terminal of the second initialization module and a control terminal of the compensation module are both connected to the second control signal line,
wherein each row of pixel circuits is connected to one of the scan signal lines, one of the first control signal lines, and one of the second control signal lines, respectively, the plurality of scan signal lines are configured to transmit a scan signal to the first voltage writing unit of the pixel circuit row by row, the plurality of second control signal lines are configured to simultaneously transmit a second control signal to the compensation modules and the second initialization modes of all rows of pixel circuits, and the plurality of first control signal lines are configured to simultaneously transmit a first control signal to the second voltage writing units of all rows of pixel circuits;
the display panel further comprises a gate driving circuit, the gate driving circuit is connected to the plurality of scan signal lines and configured to output the scan signal through the scan signal lines stage by stage; and
the display panel further comprises a chip binding area, and the plurality of first control signal lines and the plurality of second control signal lines are respectively connected to the chip binding area.
